(19) United States
(12) Patent Application Publication
(10) Pub. No.: US 2025/0042813 A1
(43) Pub. Date: Feb. 6, 2025

(54) COMPOSITE MATERIAL

(71) Applicant: OCS 2 UG (HAFTUNGSBESCHRÄNKT), Kitzscher (DE)

(72) Inventors: Frank BELLMANN, Weimar (DE); Horst-Michael LUDWIG, Weimar (DE)

(73) Assignee: OCS 2 UG (HAFTUNGSBESCHRÄNKT), Kitzscher (DE)

(21) Appl. No.: 18/717,528

(22) PCT Filed: Dec. 16, 2021
(86) PCT No.: PCT/EP2021/086164

§ 371 Date: Jun. 7, 2024

(51) Int. Cl. C04B 9/12; C04B 111/26

(52) U.S. Cl. CPC C04B 9/12; C04B 2111/26

(57) ABSTRACT

The invention relates to a composite material that makes use of cement stone of a MgO- and/or olivine-based binder and reinforcing elements for increasing the load-bearing capacity, wherein the reinforcing elements are resistant to pH values of less than 11 and/or have a protection against pH values of less than 11. Additionally or alternatively, agents for raising the pH value of the pore solution of the cement stone can be added to the MgO- and/or olivine-based binder of the cement stone.

### CROSS-REFERENCE TO RELATED APPLICATIONS

This application is a 371 U.S. National Phase of International Application No. PCT/EP2021/086164, filed on Dec. 16, 2021. The entire disclosure of the above application is incorporated herein by reference.

### FIELD

The invention relates to a composite material composed of cement stone and reinforcement elements.

### BACKGROUND

The use of reinforced concrete is indispensable for the construction industry in its current form. In reinforced concrete, the concrete absorbs compressive stresses, while the steel reinforcement inserts are responsible for transferring tensile forces. At the same time, the concrete protects the steel from corrosion. This corrosion protection is based on a very high pH value in the pore solution of concrete. With a pH value of around 11 or higher, normal reinforcing steel no longer rusts because very thin passivation layers form on the surface, which seal the steel surface against the ingress of oxygen and water and thus prevent corrosion. In the pore solution of concretes produced with cements in accordance with DIN EN 197, pH values of more than 12.5 are present and the use of these cements therefore represents effective corrosion protection for steel reinforcement. The composite construction material reinforced concrete provides high performance and durability at low cost and is often used for these reasons. However, the production of reinforcing steel is associated with high environmental impacts, including high CO₂ emissions during the production of raw iron and steel.

Various alternative materials have been proposed to reduce carbon dioxide emissions during the production of the reinforcement. These include carbon and glass fibers, in particular. Both materials have very high tensile strengths and can also be used to transfer the tensile forces in reinforced concrete. Another advantage is the corrosion resistance of both fiber types. Both carbon and glass fibers do not normally react with water and/or oxygen.

However, high pH values can have a detrimental effect on the bonding effect and durability of carbon fiber and/or glass fibers. For this reason, the use in standard cements in accordance with DIN EN 197 may lead to difficulties, as these cements have high pH values in the pore solution. With glass fibers, such high pH values can dissolve the fibers and thus weaken them. For this reason, glass types with a higher chemical resistance to alkalis must be used as reinforcement in concrete construction or the glass must be protected from direct contact with the pore solution of the cement stone with a protective coating. In the case of carbon fibers, the plastics with which the individual carbon fibers are bonded together can be impaired. High pH values can therefore lead to damage in both types of reinforcement.

The use of mineral fibers with an inorganic binder such as cement is known from DE 2409231 A1. To avoid the problems described above, it is proposed to reduce the pH value by additional treatment with CO₂.

Furthermore, a binder based on magnesium oxide and aluminum phosphate is known from U.S. Pat. No. 5,002,610, which hardens very quickly. However, the manufacturing process is extremely complicated and requires multiple drying, grinding and remixing of various components.

### SUMMARY

This section provides a general summary of the disclosure and is not a comprehensive disclosure of its full scope or all of its features.

The object underlying the invention is therefore that of providing a composite material which may comprise, as a reinforcement element, carbon fibers, glass fibers and also steel reinforcements.

According to the invention, this object is achieved by means of a composite material having the features of claim 1.

Further advantageous embodiments are specified in the dependent claims, the further description and the exemplary embodiments.

According to claim 1, it is provided that the composite material according to the invention comprises cement stone composed of MgO- and/or olivine-based binders. The olivine-based binders use as starting material a forsterite source in the form of a natural or artificial olivine source and/or in the form of tempered serpentinite. In terms of the invention, tempered serpentinite can be understood in particular as serpentinite which has been heated to a temperature of at least 500° C. Instead of the technical term “tempered”, the term “calcined” is often used.

Furthermore, the composite material according to the invention comprises reinforcing elements for increasing the load-bearing capacity. According to the invention, these reinforcing elements are resistant to pH values of below 11, have a protection against pH values of below 11 and/or agents for raising the pH value of the pore solution of the cement stone to a pH value of at or above 11 are added to the MgO- and/or the olivine-based binder of the cement stone. In other words, at least one of the above-mentioned three conditions is provided according to the invention.

### DETAILED DESCRIPTION

A basic idea of the invention can be seen in deviating from known portland cement-based cements, which have a relatively high pH value. According to the invention, it has been recognized that the pore solution of a cement stone made of MgO- or an olivine-based binder, as understood according to the invention, usually has pH values of less than 11. This makes it possible to use reinforcing elements made of glass fibers or carbon fibers or combinations of both, which are not stable against media at pH values above 11 without further treatment.

If other reinforcing elements are to be used, it is in accordance with the invention to provide them with protection against the pH values of less than 11 present in the pore solution of the cement stone according to the invention.

As an alternative or in addition to this, depending on the reinforcing agent used, other agents can be added to the MgO- and/or olivine-based binder to raise the pH value of the pore solution to a pH value of higher than 11. For example, slaked lime, quicklime, alkalines such as sodium hydroxide or potassium hydroxide, CKD (cement kiln dust, kiln dusts from cement production) can be added for this purpose.

At least when using tempered serpentinite in the starting product, but preferably also when using a natural or artificial olivine source, the starting product should be free of alite and belite, as these can cause hardening disorders. A manufacturing process for cement stone from a MgO- and/or olivine-based binder is described, for example, in PCT/EP2021/061726.

It is advantageous if the pore solution of the cement stone has a pH value of 11 or lower. This is particularly the case if the cement stone according to the invention consists of a MgO- and/or olivine-based binder. In this way, no further adjustments need to be made to the base material of the cement stone for use with reinforcement elements made of glass fiber and/or carbon fiber.

It is advantageous if the MgO- or olivine-based binder comprises MgO and SiO₂, MgO and MgCO₃, MgO and glass powder, olivine and SiO₂, olivine and glass powder, olivine and trass, olivine and pozzolan, tempered serpentinite and SiO₂, tempered serpentinite and glass powder and/or individually or combinations thereof. By using these starting materials, a cement stone can be produced that has good strength compared to mixtures based on Portland cement, and yet has a pH of 11 or lower.

Trass is a natural pozzolan consisting mainly of silicon compounds and aluminum compounds. Pozzolans are artificial or natural rocks made of silicon dioxide, alumina, limestone, iron oxide and alkaline substances, which are usually formed under the influence of heat. When combined with calcium hydroxide and water, they are capable of binding.

In principle, any reinforcing elements according to the invention can be used. However, it is particularly advantageous if the reinforcing elements comprise carbon fibers and/or glass fibers. These fibers provide the advantage over conventional steel reinforcements that they are lighter on the one hand and on the other hand produce significantly less CO₂ during production.

It is advantageous if the reinforcement element is configured without a protective layer to resist pH values of less than 11. This is particularly possible with reinforcement elements made of carbon fiber and/or glass fiber. In principle, however, a protective layer can also be applied against such low pH values.

It is further advantageous if the carbon fiber and/or glass fibers are in the form of fiber reinforcements, mesh reinforcements, bar reinforcements and other forms of reinforcement. The advantage of using carbon fiber and/or glass fibers is that they can be formed into any shape and then can be used to produce the composite material. This means that an optimum form of reinforcement can be provided depending on the expected load.

In a further embodiment, steel reinforcements may alternatively or additionally be present in the composite material according to the invention. If these are used, it is preferable to add Portland cement clinker in particular, to the cement stone in addition to the MgO- and/or olivine-based binder. This is particularly suitable for increasing the pH value so that corrosion of steel reinforcement is prevented due to the low pH value. In addition, Portland cement clinker has the advantage over other substances that influence the pH value that it makes its own separate contribution to strength.

It may also be provided that the reinforcing elements have at least one protective layer to protect against an alkaline environment with a pH value of less than 11. This protective layer can be applied, for example, by applying paint and/or varnish. The protective layer can be plastic-based. Another option is to apply a hot-dip galvanizing to steel reinforcements.

To verify the invention, the pore solution of two binders according to the invention was examined in more detail after six months of hydration.

Firstly, a binder made of pure synthetic forsterite without foreign ions was analyzed. In a second sample, a mixture of forsterite and silica glass in a ratio of 2:1 was used instead of pure forsterite to produce the cement stone of the composite material.

After half a year of hydration, the pH value in the first sample was 9.5 and in the second sample the pH value was even in the region of 8.2.

Accordingly, the use of forsterite, which belongs to the olivine group, makes it possible to produce a binder for a composite material that has a very low pH value compared to cement stone made from classic Portland cement clinker. Due to this low pH value, glass and/or carbon fiber reinforcements can be used for the first time without further pre-treatment.

Using the composite material according to the invention, it is thus possible to dispense with the use of steel reinforcements, which have very high CO₂ emissions during their manufacture.

1-10. (canceled)

11. A composite material, comprising:
cement stone composed of an MgO-based binder and/or olivine-based binder, which comprises, as a starting material, a forsterite source in the form of a natural or artificial olivine source and/or in the form of tempered serpentinite, as well as reinforcing elements for increasing the load-bearing capacity, wherein the reinforcing elements comprise:
carbon fibers and/or glass fibers which are resistant to pH values below 11, and/or
steel reinforcements, which are hot-dipped and/or comprise a layer of paint or varnish, whereby they have protection against pH values of less than 11.2

12. The composite material according to claim 11,
wherein the pore solution of the cement stone has a pH value of 11 or lower.

13. The composite material according to claim 11,
wherein the MgO-based binder and/or olivine-based binder comprises MgO and SiO₂, MgO and MgCO₃, MgO and glass powder, olivine and SiO₂, olivine and glass powder, olivine and trass, olivine and pozzolan, tempered serpentinite and SiO₂, tempered serpentinite and glass powder, or combinations thereof.

14. The composite material according to claim 11,
wherein the reinforcing elements are configured without a protective layer to resist pH values of less than 11.

15. The composite material according to claim 11, wherein the carbon fiber and/or glass fibers are in the form of fiber reinforcement, mesh reinforcement, bar reinforcements and/or other forms of reinforcement.

16. The composite material according to claim 11,
wherein a binder that comprises Portland cement clinker is added to the cement stone for producing, in addition to the MgO-based binder and/or olivine-based binder.

17. The composite material according to claim 11,
wherein the reinforcing elements as paint or varnish layer comprise a layer of paint or varnish made of plastic, for protection against an alkaline environment with a pH value of less than 11.
